(19) United States
(12) Patent Application Publication
(10) Pub. No.: US 2016/0365000 A1
(43) Pub. Date: Dec. 15, 2016

(54) EXERCISE INSTRUCTION SYSTEM, INSTRUCTION CONTENT GENERATION METHOD, EXERCISE INSTRUCTION DEVICE, AND INSTRUCTION CONTENT GENERATION DEVICE

(71) Applicant: Seiko Epson Corporation, Tokyo (JP)

(72) Inventors: Michihiro Nagaishi, Suwa-shi (JP); Hideto Yamashita, Suwa-shi (JP)

(21) Appl. No.: 15/161,454

(22) Filed: May 23, 2016

(30) Foreign Application Priority Data
Jun. 10, 2015 (JP) 2015-117858

(51) Int. Cl. G09B 19/00; A63B 24/00; A63B 69/00; G09B 5/02; A63B 69/36; A63B 69/38

(52) U.S. Cl. CPC G09B 19/0038; A63B 69/3608; A63B 69/38; A63B 69/0017; A63B 69/0002; G09B 5/02; A63B 24/0006; A63B 24/0062

(57) ABSTRACT

An exercise instruction system includes: a body motion detection device (measuring device) which detects a body motion of a user; a muscle mass measuring device (measuring device) which measures a muscle mass of the user; and an exercise instruction device (information processing device) which presents an instruction content on an exercise that should be carried out by the user, on the basis of a result of detection by the body motion detection device (measuring device) and a result of measurement by the muscle mass measuring device (measuring device).

### CROSS-REFERENCES TO RELATED APPLICATIONS

This application claims priority to Japanese Patent Application No. 2015-117858, filed Jun. 10, 2015, the entirety of which is herein incorporated by reference.

### BACKGROUND

1. Technical Field

The present invention relates to an exercise instruction system, an instruction content generation method, an exercise instruction device, and an instruction content generation method.

2. Related Art

According to the related art, a physical training advice device is known which measures a real muscle mass, that is, a muscle mass of each body part of a subject, then displays this real muscle mass and an ideal muscle mass, and also displays a training menu for the subject to follow (see JP-A-2008-35876, for example).

In the physical training advice device disclosed in JP-A-2008-35876, the measured muscle mass is measured and calculated with respect to the seven positions of the trunk, left and right upper arms, left and right forearms, and left and right lower legs. After that, on the basis of this measured muscle mass, an ideal muscle mass in consideration of the gender and height of the subject is calculated and a target muscle mass which is 110 percent of the current muscle mass (total body muscle mass) is calculated as well. The measured muscle mass, the ideal muscle mass and the target muscle mass are displayed as a graph in the form of a radar chart, and an exercise menu based on the respective muscle masses is prepared and presented. The training menu includes, for example, target values (numbers of times) of exercise items such as bench press and upright row based on the balance between a maximum muscle strength estimated from the current muscle and a maximum muscle strength estimated from the ideal muscle mass.

By carrying out the exercise menu presented in this manner, the subject can do training without overloading the muscles.

Some exercises carried out by the user include a specific movement. Such a movement may be, for example, a swing of a club in golf, a swing of a bat in baseball, or a running form in running. By improving the quality of such a movement, the user can improve his/her performance in the sport.

However, the physical training advice device disclosed in JP-A-2008-35876 focuses on making the user carry out an exercise that can increase the muscle mass, and therefore raises the problem of poor relevance of advice to the body movement of the user at the time of exercise.

### SUMMARY

An advantage of some aspects of the invention is to provide an exercise instruction system, an instruction content generation method, an exercise instruction device and an instruction content generation device that enable instructions on an exercise suitable for the user.

An exercise instruction system according to a first aspect of the invention includes: a body motion detection device which detects a body motion of a user; a muscle mass measuring device which measures a muscle mass of the user; and an exercise instruction device which presents an instruction content on an exercise that should be carried out by the user, on the basis of a result of detection by the body motion detection device and a result of measurement by the muscle mass measuring device.

According to the first aspect, an instruction content on an exercise that should be carried out by the user is presented on the basis of the body motion of the user detected by the body motion detection device and the muscle mass of the user measured by the muscle mass measuring device. Thus, an instruction content that enables improvement of a problem in the movement due to the muscle mass can be presented to the user, and the user can carry out an effective exercise by following the instruction content. Therefore, an instruction on an exercise suitable for the user can be given.

In the first aspect, it is preferable that the instruction content is an instruction content that improves a specific movement in a sport.

Such a specific movement may be, for example, a swing of a club in golf, a swing of a bat in baseball, and a swing of a racket in tennis, badminton or the like.

Here, by improving the swing mentioned above as a specific movement, the user can improve his/her performance in the sport. Therefore, according to the first aspect, since an instruction content that improves the specific movement is presented, the user can improve his/her performance in the sport by carrying out the specific movement on the basis of the instruction content. Also, whether the specific movement such as a swing in a sport is good or bad can be determined relatively easily because an ideal form of the specific movement is already established. Therefore, a problem in the movement of the user can be grasped relatively easily and an instruction suitable for the user can be securely given.

In the first aspect, it is preferable that the exercise instruction system has an instruction content generation device which generates the instruction content, that the instruction content generation device includes a difference extractor which extracts a difference of the specific movement from an ideal form on the basis of the result of the detection by the body motion detection device when the user carries out the specific movement, and an instruction content generator which generates the instruction content corresponding to a muscle site which resolves the difference that is extracted, on the basis of the muscle mass of the user measured by the muscle mass measuring device, and that the exercise instruction device presents the instruction content generated by the instruction content generation device.

The instruction content generation device may be integrated with or separate from the exercise instruction device.

According to the first aspect with this configuration, the difference extractor of the instruction content generation device extracts the difference of the movement made by the user from the ideal form of the specific movement, and the instruction content generator generates the instruction content corresponding to the muscle site that resolves the difference, on the basis of the measured muscle mass. Thus, by giving an instruction on the way of moving the muscle or an instruction on the muscle with insufficient muscle strength, it is possible to bring the movement of the user closer to the ideal movement. Therefore, the user can carry out an effective exercise on his/her own.

In the first aspect, it is preferable that the instruction content generator generates the instruction content including a muscle site that should be trained in order to resolve the difference.

According to the first aspect with this configuration, by training the muscle indicated by the presented instruction content, the user can securely bring his/her movement closer to the ideal movement. Therefore, the user can carry out an effective exercise on his/her own.

In the first aspect, it is preferable that the instruction content generator generates the instruction content including away of using the muscle which resolves the difference.

According to the first aspect with this configuration, by putting into practice the way of using the muscle indicated by the presented instruction content, the user can securely bring his/her movement closer to the ideal movement. Therefore, the user can carry out an effective exercise on his/her own.

In the first aspect, it is preferable that the instruction content generation device has a memory which stores the ideal form, and that the difference extractor acquires the ideal form corresponding to the specific movement from the memory and extracts the difference.

According to the first aspect with this configuration, since the ideal form is stored in the memory, the ideal form and the specific movement carried out by the user can be securely compared with each other and the difference can be securely extracted. Thus, the instruction content to improve the specific movement carried out by the user can be securely presented.

In the first aspect, it is preferable that the exercise instruction device includes an input unit which accepts an input operation by the user, and a type acquirer which acquires a scheduled exercise type which is a type of exercise scheduled to be carried out by the user, on the basis of the input operation, and that the difference extractor acquires the ideal form from the memory on the basis of the scheduled exercise type that is acquired.

According to the first aspect with this configuration, since the type acquirer acquires the scheduled exercise type for the user, the ideal form corresponding to the scheduled exercise type can be acquired from the memory securely and swiftly, and comparison between an ideal form of a different type and the movement of the user can be restrained. Therefore, an appropriate instruction on the exercise carried out by the user can be securely given.

In the first aspect, it is preferable that the muscle mass measuring device has a measurer which is mounted on the user for measuring the muscle mass, and that the exercise instruction device includes an input unit which accepts an input operation by the user, a type acquirer which acquires a scheduled exercise type which is a type of exercise scheduled to be carried out by the user, on the basis of the input operation, and a measurement site presenter which presents a measurement site where the measurer is mounted to measure the muscle mass, on the basis of the scheduled exercise type that is acquired.

According to the first aspect with this configuration, the measurement site presenter presents the measurement site corresponding to the scheduled exercise type for the user. Thus, the measurer can be restrained from being mounted at a site unsuitable for the scheduled exercise type, and the measurer can be securely mounted at an appropriate site on the user's body. Therefore, the muscle mass at the appropriate site can be securely measured.

An instruction content generation method according to a second aspect of the invention is carried out using an instruction content generation device which generates an instruction content on an exercise carried out by a user. The method includes: measuring a body motion and a muscle mass of the user; and generating an instruction content on an exercise that should be carried out by the user, on the basis of a result of the measurement of the body motion and the muscle mass.

According to the second aspect, the instruction content generation method is carried out using the instruction content generation device, and the generated instruction content is presented to the user. Thus, effects similar to those of the exercise instruction system according to the first aspect can be achieved.

An exercise instruction device according to a third aspect of the invention includes: a body motion acquirer which acquires a result of detection of a body motion of a user; a muscle mass acquirer which acquires a result of measurement of a muscle mass of the user; and an instruction content presenter which presents an instruction content on an exercise that should be carried out by the user, on the basis of the result of the detection of the body motion and the result of the measurement of the muscle mass.

According to the third aspect, effects similar to that of the exercise instruction system according to the first aspect can be achieved.

An instruction content generation device according to a fourth aspect of the invention includes: a body motion acquirer which acquires a result of detection of a body motion of a user; a muscle mass acquirer which acquires a result of measurement of a muscle mass of the user; and an instruction content generator which generates an instruction content on an exercise that should be carried out by the user, on the basis of the result of the detection of the body motion and the result of the measurement of the muscle mass.

According to the fourth aspect, since the generated instruction content is presented to the user, as in the instruction content generation method according to the second aspect, effective similar to those of the exercise instruction system according to the first aspect can be achieved.

### BRIEF DESCRIPTION OF THE DRAWINGS

The invention will be described with reference to the accompanying drawings, wherein like numbers reference like elements.

FIG. 1 is a schematic view showing the configuration of an exercise instruction system according to a first embodiment of the invention.

FIG. 2 is a block diagram showing the configuration of an information processing device in the first embodiment.

FIG. 3 is a block diagram showing the configuration of a controller in the first embodiment.

FIG. 4 shows an example of an exercise selection screen in the first embodiment.

FIG. 5 shows an example of a measurement site presentation screen in the first embodiment.

FIG. 6 shows an example of a muscle mass presentation screen in the first embodiment.

FIG. 7 shows an example of an analysis result screen in the first embodiment.

FIG. 8 shows an example of the analysis result screen in the first embodiment.

FIG. 9 shows an example of the analysis result screen in the first embodiment.

FIG. 10 shows an example of the analysis result screen in the first embodiment.

FIG. 11 shows an example of the analysis result screen in the first embodiment.

FIG. 12 shows an example of an ideal form of a basic swing in golf in the first embodiment.

FIG. 13 shows an example of each of the difference between the content of an ideal movement and the content of a movement of the user, and the difference between ideal muscle development and the user's muscle development, in the first embodiment.

FIG. 14 shows an example of an instruction content presentation screen in the first embodiment.

FIG. 15 is a flowchart showing exercise instruction processing in the first embodiment.

FIG. 16 is a block diagram showing the configuration of an exercise instruction system according to a second embodiment of the invention.

FIG. 17 is a block diagram showing the configuration of an information processing device in the second embodiment.

FIG. 18 is a block diagram showing the configuration of a server in the second embodiment.

FIG. 19 is a flowchart showing exercise instruction processing in the second embodiment.

### DESCRIPTION OF EXEMPLARY EMBODIMENTS

Hereinafter, a first embodiment will be described with reference to the drawings.

### First Embodiment

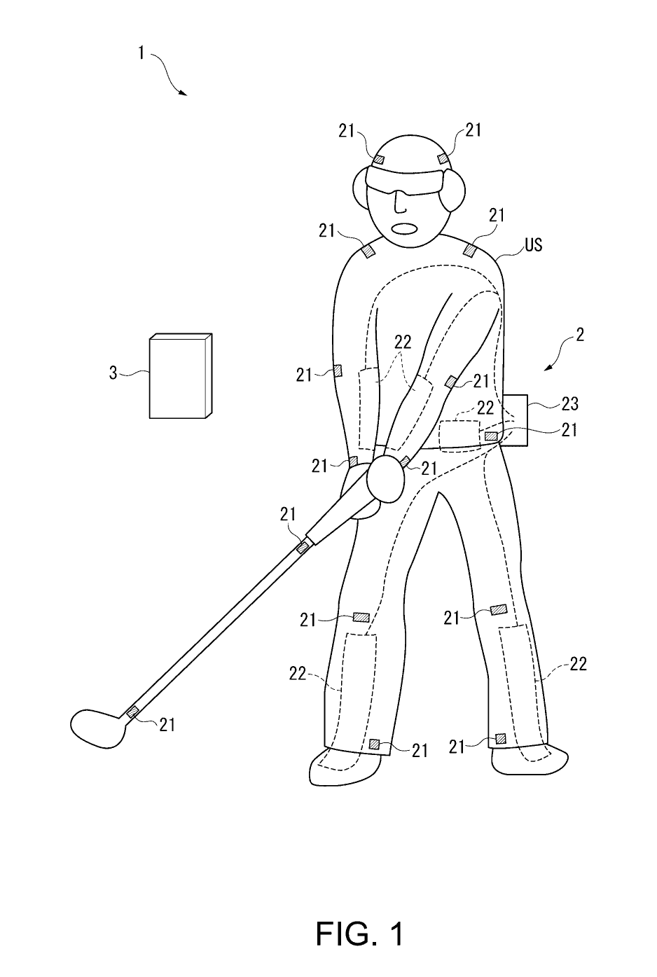

FIG. 1 is a schematic view showing the overall configuration of an exercise instruction system 1 according to the embodiment.

The exercise instruction system 1 according to the embodiment has a measuring device 2 mounted on the body of a user US, and an information processing device 3 as an exercise instruction device which presents an instruction content on an exercise that should be carried out by the user US, on the basis of the result of measurement by the measuring device 2, as shown in FIG. 1.

Specifically, in the exercise instruction system. 1, for example, to a user who wants to improve his/her golf swing, the information processing device 3 presents the way of moving the body that can solve a problem of the swing based on the result of measurement by the measuring device 2, and a site of the body that should be trained in order to solve the problem, thus improving the swing and hence enhancing the quality of the swing.

Hereinafter, the configuration of the exercise instruction system 1 will be described in detail.

### Configuration of Measuring Device

The measuring device 2 is equivalent to the body motion detection device according to the invention and forms a part of the muscle mass measuring device according to the invention. The measuring device 2 has a plurality of movement sensors 21 which measures movements of each part of the user US, a plurality of measurement sheets 22 as measurers for measuring the muscle mass at measurement sites on the user US, and a controller 23 which controls the operations of the movement sensors 21 and the measurement sheets 22 and transmits the results of measurement by these, to an external device (for example, the information processing device 3).

### Configuration of Movement Sensor

Each movement sensor 21 includes an acceleration sensor and a gyro sensor and is mounted at a site (for example, a joint) that serves as a node at the time of exercise, in the body of the user US, or at a site (for example, the head) with a large movement. Specifically, in this embodiment, the movement sensors 21 are mounted on the head, shoulders, elbows, wrists, lumbar, knees, and ankles, as shown in FIG. 1. These movement sensors 21 communicate with the controller 23 via wireless communication conforming to a communication standard such as near field radio communication, and transmit their respective results of detection to the controller 23. However, this example is not limiting. Each movement sensor 21 may be wire-connected to the controller 23.

### Configuration of Measurement Sheet

The measurement sheets 22 are wire-connected to the controller 23. The measurement sheets 22 conduct a current inputted from the controller 23, to the measurement sites, and output a current inputted as it is conducted through the body, to the controller 23.

In the example of FIG. 1, such measurement sheets 22 are mounted on the left and right forearms and lower legs because the exercise carried out by the user US is a swing of a golf club. However, the mounting position (attachment positions) of the measurement sheets 22 are changed according to the type of exercise to be carried out by the user. That is, the measurement sheets 22 are attached to sites where the muscle mass is to be measured, of the body of the user US. As the user US inputs a type of exercise scheduled to be carried out, to the information processing device 3, described later, such attachment positions are displayed on the information processing device 3. Then, by mounting the measurement sheets 22 on the body according to the content displayed on the information processing device 3, the user US can mount the measurement sheets 22 at appropriate positions and can also measure the muscle mass at sites necessary for the exercise of this type.

The muscle mass is calculated on the basis of a biological impedance value calculated on the basis of the voltage value of a current outputted to the body via the measurement sheets 22 and the voltage value of a current inputted to the measurement sheets 22 via the body, and also on the basis of user information such as the weight of the user US. In the embodiment, the information processing device 3, described later, carries out the calculation of the muscle mass. However, if the controller 23 can acquire the user information, the controller 23 may calculate the muscle mass.

### Configuration of Controller

The controller 23 is wirelessly connected or wire-connected to the respective movement sensors 21 and the respective measurement sheets 22 and controls operations of these components. The controller 23 is also wireless connected or wire-connected to the information processing device 3 and transmits the results of measurement by the movement sensors 21 and the measurement sheets 22 as measurement result information.

Specifically, the controller 23 acquires the results of measurement received from the respective movement sensors 21 (the results of detection of acceleration and angular velocity at each site corresponding to the movement of the user US).

The controller 23 also supplies a current to the respective measurement sheets 22, acquires the voltage values of currents inputted from these measurement sheets 22, and calculates the biological impedance value for each measurement sheet 22 (that is, for each measurement site).

The controller 23 then transmits measurement result information including the results of the detection by the movement sensors 21 and the biological impedance values at the respective measurement sites, to the information processing device 3.

In the embodiment, the controller 23 calculates the biological impedance value. However, this example is not limiting and the information processing device 3, described later, may calculate the biological impedance value. In such a case, the controller 23 may transmit the voltage value of the current supplied to the measurement sheets 22 and the voltage values of the currents inputted from the measurement sheets 22, to the information processing device 3.

### Configuration of Information Processing Device

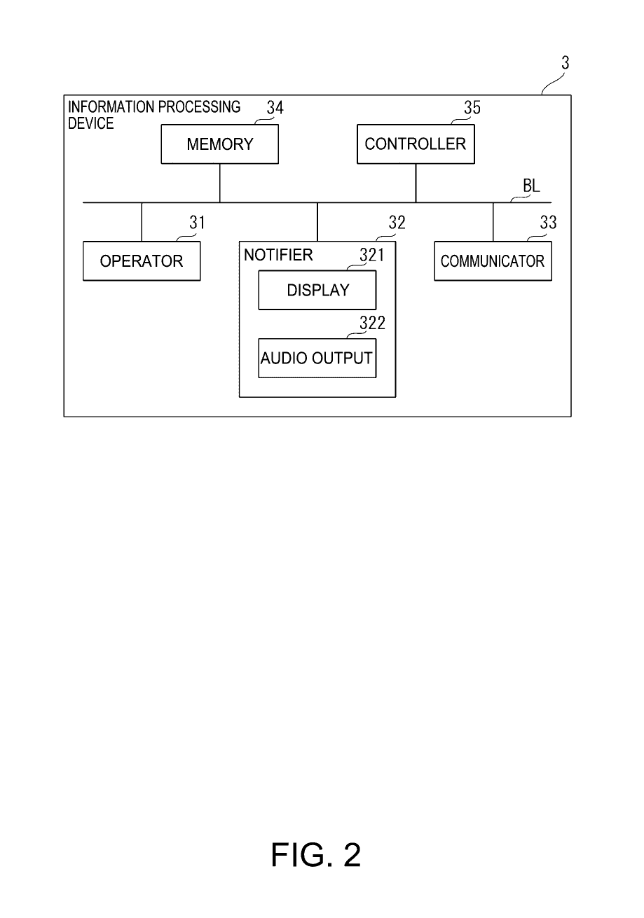

FIG. 2 is a block diagram showing the configuration of the information processing device 3.

The information processing device 3 in this embodiment is equivalent to the exercise instruction device and the instruction content generation device according to the invention and is made up of, for example, a smartphone (multi-functional mobile phone), tablet or PC (personal computer). The information processing device 3 generates and presents an instruction content on an exercise that should be carried out by the user US, on the basis of the measurement result information received from the measuring device 2. The information processing device 3 has an input unit 31, a output unit 32, a communicator 33, a memory 34, and a controller 35, and these components 31 to 35 are electrically connected to each other via a bus line BL, as shown in FIG. 2.

### Configuration of Input Unit

The input unit 31 accepts an input operation by the user US and outputs an operation signal corresponding to the input operation, to the controller 35. The input unit 31 can be made up of, for example, physical keys, a touch panel or the like provided on the casing of the information processing device 3, and can also be made up of a keyboard and pointing device or the like wire-connected or wirelessly connected to the information processing device 3.

### Configuration of Output Unit

The output unit 32 notifies the user US of various kinds of information under the control of the controller 35. The output unit 32 has a display 321 and an audio output 322.

The display 321 has a display panel of various kinds such as liquid crystal and displays a predetermined image under the control of a notification controller 352, described later. Such an image may be, for example, an in-execution screen for an application generated by a screen generator 354, described later. Therefore, the display 321 forms the instruction content presenter and the measurement site presenter according to the invention.

The audio output 322 has an audio output measure such as a speaker and outputs a sound corresponding to audio information inputted from the controller 35.

The output unit 32 in this embodiment has no vibrator. However, if the information processing device 3 is made up of a smartphone or tablet, the output unit 32 may have a vibrator which vibrates in response to a control signal inputted from the controller 35 so as to notify the user of predetermined information.

### Configuration of Communicator

The communicator 33 has a first communication module capable of communicating with the measuring device 2, and a second communication module capable of communication with an external device on a network such as the internet, and communicates with each of these devices under the control of the controller 35. If the communicator 33 can communicate with the external device on the network by the same communication method as in the communication with the measuring device 2, the communicator 33 only needs to have one of the first communication module and the second communication module. If there is no need to communicate with the external device on the network, the communicator 33 need not have the second communication module.

### Configuration of Memory

The memory 34 is made up of an HDD (hard disk drive), SSD (solid state drive) or flash memory or the like, and stores various programs and data that are necessary for operations of the information processing device 3. As such programs, the memory 34 stores, for example, an OS (operating system) and an exercise instruction application to execute exercise instruction processing, described later (an application including an exercise instruction program). In addition, as the data, the memory 34 stores personal information such as the height, weight, age, gender and the like of the user inputted by the user US.

The memory 34 also stores the measurement result information received from the measuring device 2 via the communicator 33. In this case, the memory 34 stores the measurement result information in association with the time and date when the measurement result information is acquired. Time and date information indicating such time and date may also be included in the measurement result information as information indicating the time and date of measurement and thus transmitted from the measuring device 2.

Moreover, the memory 34 stores a muscle site that should be measured, the content of an ideal movement of the body, and ideal muscle development, for each type of exercise which the user US is going to carry out (hereinafter referred to as a scheduled exercise type).

Of these, the muscle site that should be measured is, in other words, the measurement site with the measurement sheet 22. The measurement site stored in the memory 34 for each type is a site that needs to be measured at least with respect to the type in question, and there is no problem if the user US himself/herself mounts the measurement sheets 22 at other sites.

The ideal movement of the body is, in other words, the result of detection by the movement sensor 21 when the movement of the body is made. Hereinafter, the content of the ideal movement of the body and the ideal muscle development for each scheduled exercise type are collectively referred to as an ideal form.

The movement of the body for each scheduled exercise type may be, for example, the movement of the body in each of a basic swing in golf, a club-specific swing which is a swing in the case of using a golf club such as a driver or iron, and a use-specific swing for approach, putting or the like.

### Configuration of Controller

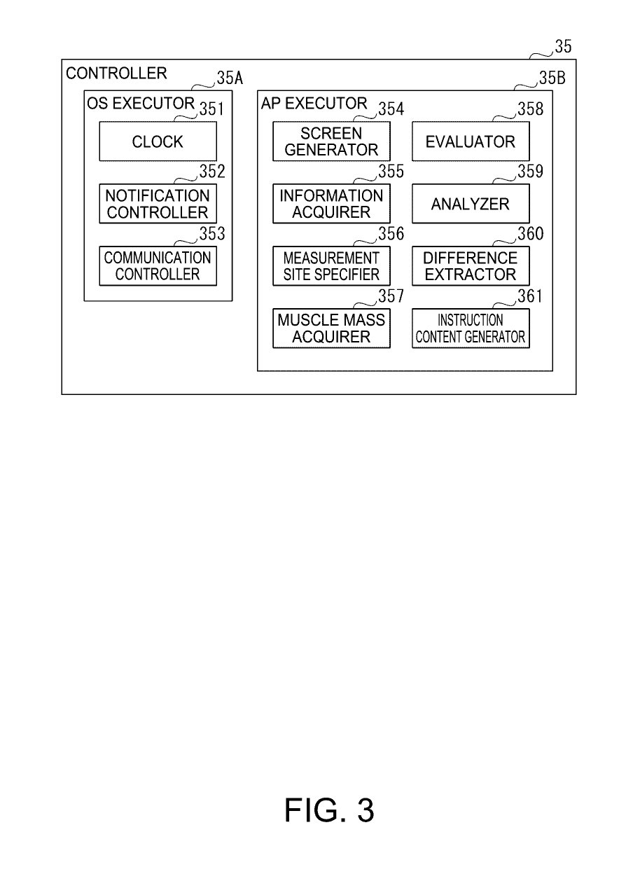

FIG. 3 is a block diagram showing the configuration of the controller 35.

The controller 35 has a processing circuit such as a CPU (central processing unit) and executes programs stored in the memory 34, thus controlling operations of the information processing device 3. The controller 35 has an OS executor 35A and an AP executor 35B, as shown in FIG. 3.

### Configuration of OS Executor

The OS executor 35A is a functional component which executes the OS stored in the memory 34, and has a clock 351, a notification controller 352, and a communication controller 353.

The clock 351 measures the current time and date.

The notification controller 352 has a display controller and an audio output controller, though not illustrated. The display controller causes the display 321 to display an image of an in-execution screen of the OS, and also acquires in-execution screens of various applications from the AP executor 35B and causes the display 321 to display these screens. The audio output controller outputs an audio signal generated at the time of executing the OS or the programs, and causes the audio output 322 to output a sound corresponding to the audio signal.

The communication controller 353 controls communication by the communicator 33 with the external device.

### Configuration of AP Executor

The AP executor 35B executes an application designated by the OS executor 35A in response to an operation signal inputted from the input unit 31, of the applications stored in the memory 34. The AP executor 35B has a screen generator 354, an information acquirer 355, a measurement site specifier 356, a muscle mass acquirer 357, an evaluator 358, an analyzer 359, a difference extractor 360 and an instruction content generator 361 which function by having the exercise instruction application executed.

### Configuration of Screen Generator

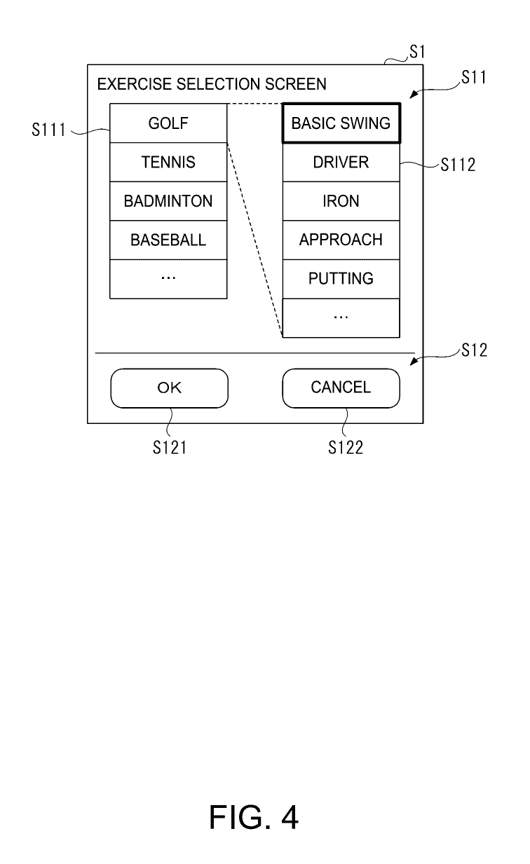

FIG. 4 shows an example of an exercise selection screen S1 for selecting a scheduled exercise type. In FIG. 4, the exercise selection screen S1, where golf is selected in a sports selection section S111 and where the basic swing is selected in a type selection section S112, is shown.

The screen generator 354 generates an in-execution screen of the exercise instruction application. For example, the screen generator 354 generates the exercise selection screen S1 whose example is shown in FIG. 4, when this exercise instruction application is executed. The exercise selection screen S1 is displayed on the display 321 by the display controller.

The exercise selection screen S1 is a screen for selecting a type of exercise to be carried out by the user US (scheduled exercise type), and includes a detail display area S11 and a button area S12. In the button area S12, of these, an OK button S121 and a cancel button S122 are arranged.

In the detail display area S11, a plurality of sports selection sections S111 in which the names of respective sports are given is arranged on the left. When one of these selection sections S111 is selected, a plurality of type selection sections S112 in which specific movements in the sport indicated in this selection section S111 are given is displayed. When a scheduled exercise type is selected by the user US from these type selection sections S112 and the OK button S121 is pressed, the scheduled exercise type for the user US is inputted.

If the cancel button S122 is pressed, this exercise selection screen S1 disappears.

The screen generator 354 also generates a measurement site presentation screen S2, a muscle mass presentation screen S3, an instruction content presentation screen S4 and an analysis result screen DS (DS1 to DS5), described later. These screens, too, are displayed on the display 321 by the display controller.

### Configuration of Information Acquirer

Back to FIG. 3, the information acquirer 355 acquires various kinds of information inputted to the information processing device 3. Specifically, the information acquirer 355 acquires the content of an input operation by the user US on the basis of an operation signal inputted from the input unit 31. For example, on the basis of an operation signal inputted from the input unit 31 at the time of displaying the exercise selection screen S1, the information acquirer 355 acquires the scheduled exercise type selected by the user US. That is, the information acquirer 355 includes the functions of the type acquirer according to the invention.

The information acquirer 355 also acquires the measurement result information from the measuring device 2 via the communicator 33 and stores the measurement result information in the memory 34 in association with time and date.

### Configuration of Measurement Site Specifier

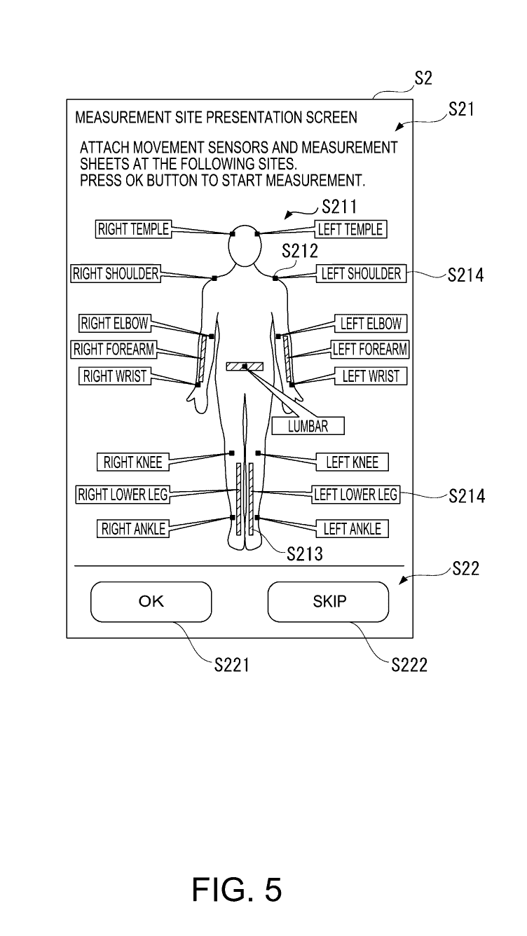

FIG. 5 shows an example of a measurement site presentation screen S2 showing measurement sites with the movement sensors 21 and the measurement sheets 22 corresponding to the scheduled exercise type selected by the user US.

The measurement site specifier 356 acquires from the memory 34 a site (measurement site) where the muscle mass of a necessary muscle for the exercise of the scheduled exercise type acquired by the information acquirer 355, that is, a site (mounting site) where the measurement sheet 22 is to be mounted, and specifies the site. Thus, the screen generator 354 generates the measurement site presentation screen S2 whose example is shown in FIG. 5, and causes the display 321 to display the screen S2. In this case, the screen generator 354 is equivalent to the measurement site presenter according to the invention, which presents a site where the measurement sheet 22 as a measurer is to be mounted to measure the muscle mass.

The measurement site presentation screen S2 includes a detail display area S21 and a button area S22.

In the detail display area S21, a figure S211 in the shape of a human body is set, and figures S212 (black squares) indicating detection sites with the movement sensors 21, figsures S213 (shaded rectangles) indicating measurement sites with the measurement sheets 22, and characters 5214 indicating mounting positions of the movement sensors 21 and the measurement sheets 22 are arranged.

In the button area S22, an OK button S221 and a skip button S222 are arranged. Of these, if the OK button S221 is pressed, a control signal to execute measurement of the muscle mass using each measurement sheet 22 (in this embodiment, calculation of biological impedance values) is outputted to the measuring device 2 via the communicator 33. The controller 23, having received this control signal, executes the measurement of the voltage of the current conducted through the body of the user US and the calculation of the biological impedance, and transmits measurement result information including these to the information processing device 3.

If the skip button S222 is pressed, the muscle mass measurement processing is not carried out and only the movement detection using the movement sensors 21 is carried out.

### Configuration of Muscle Mass Acquirer

The muscle mass acquirer 357 acquires the muscle mass at each measurement site on the user US. Specifically, the muscle mass acquirer 357 calculates the muscle mass at each measurement site on the basis of the biological impedance value at each measurement site, of the measurement result information received from the measuring device 2. That is, in the embodiment, the muscle mass acquirer 357 and the measuring device 2 form the muscle mass measuring device according to the invention.

If measurement result information including the muscle mass at each measurement site is received from the measuring device 2, the muscle mass acquirer 357 acquires the muscle mass at each measurement site from the measurement result information. Meanwhile, if the applied voltage value to each measurement site and the voltage value inputted to the measurement sheets 22 as it is conducted through the body are acquired from the measurement result information, the muscle mass acquirer 357 carries out the calculation of the biological impedance values and the calculation of the muscle mass at each measurement site.

### Configuration of Evaluator

The evaluator 358 evaluates the muscle development of the user US for each scheduled exercise type, on the basis of the muscle mass at each measurement site on the user US.

Specifically, the evaluator 358 classifies the respective measurement sites into “A (well developed)”, “B (developed)”, “C (standard)”, and “D (less developed)”, on the basis of the muscle mass at each measurement site that is acquired and the range of muscle mass that is set according to the scheduled exercise type and the site on the body. For example, if the calculated muscle mass is within a range where an evaluation “C” is given, of the range that is set according to the scheduled exercise type and the measurement site, the evaluator 358 evaluates this site as “C”.

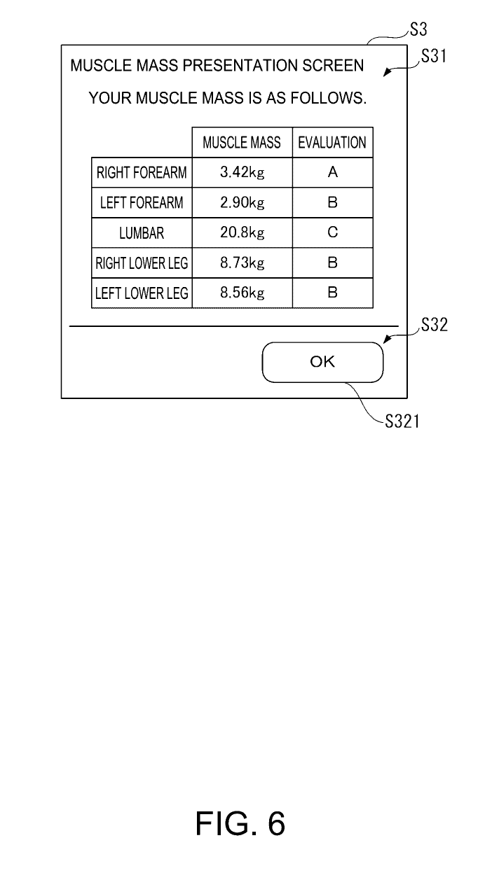

FIG. 6 shows an example of a muscle mass presentation screen S3 showing the muscle mass of the user US.

The result of the evaluation by the evaluator 358 is presented to the user US, along with the acquired muscle mass on the muscle mass presentation screen S3 whose example is shown in FIG. 6.

The muscle mass presentation screen S3 has a detail display area S31 and a button area S32.

In the detail display area S31, the muscle mass at each measurement site corresponding to the scheduled exercise type is shown, and the result of the evaluation by the evaluator 358 of the muscle development at each measurement site is set as well.

In the button area S32, an OK button S321 is arranged. When the OK button S321 is pressed, the displayed screen shifts to a predetermined screen (for example, a menu screen).

The muscle mass presentation screen S3 is not necessarily a displayed screen, and may be generated by the screen generator 354 in response to an input operation by the user US to the input unit 31 and thus displayed.

### Configuration of Analyzer

Back to FIG. 3, the analyzer 359 functions after the result of measurement by each movement sensor 21 when the user US carries out the exercise of the scheduled exercise type is acquired. The analyzer 359 analyzes the movement of the user US when carrying out the exercise of the scheduled exercise type, on the basis of the result of the measurement.

For example, if the scheduled exercise type is a basic swing in golf, the analyzer 359 analyzes the movement of the user US in terms of the respective analysis items of swing, impact, speed, shaft rotation, and tempo, on the basis of the result of the measurement.

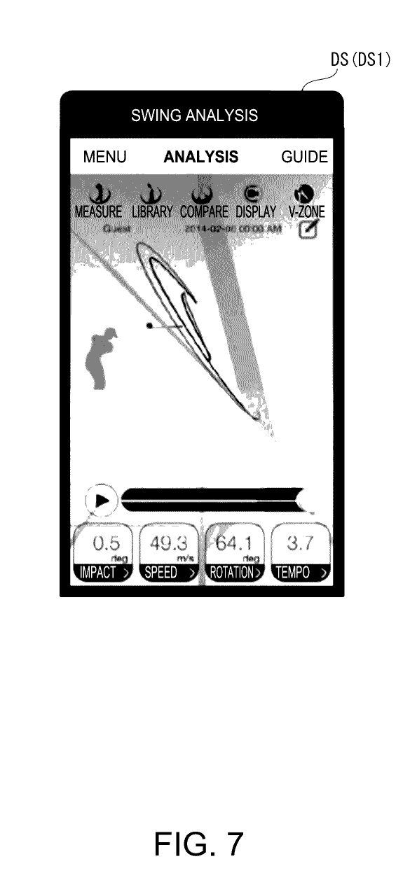

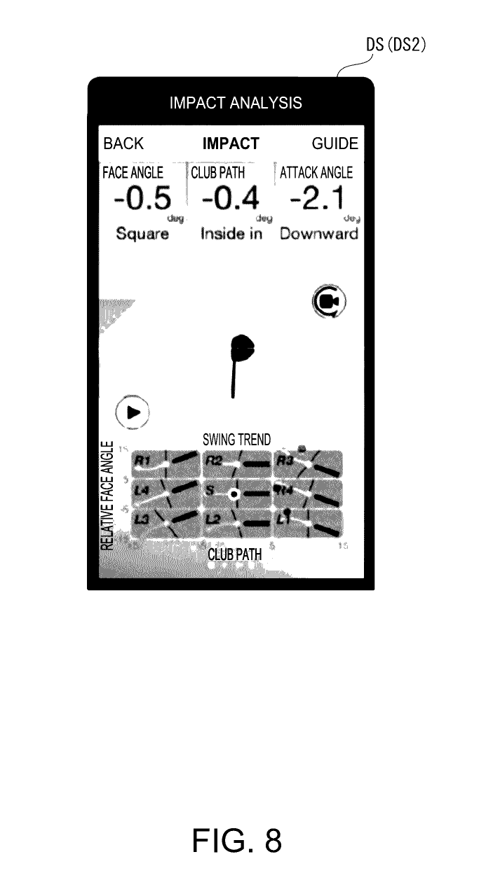

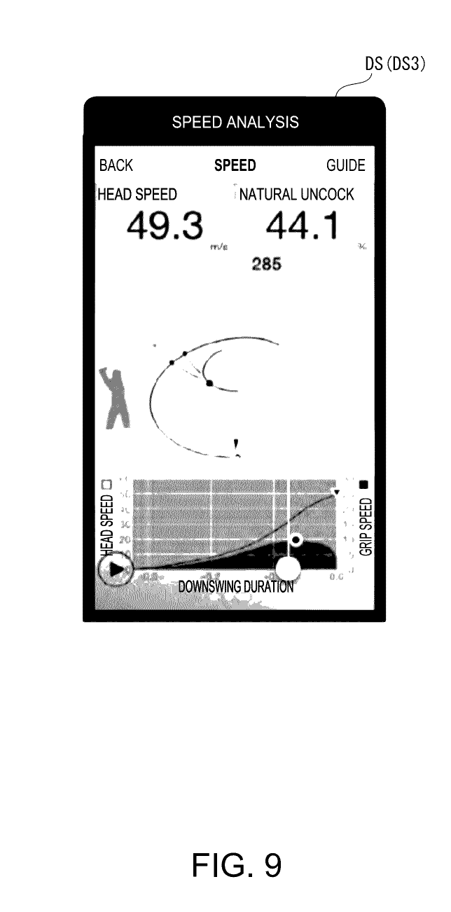

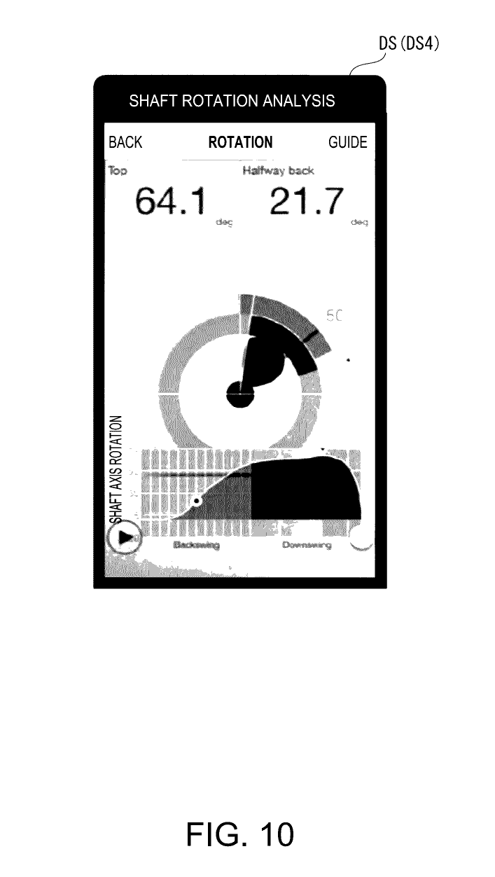

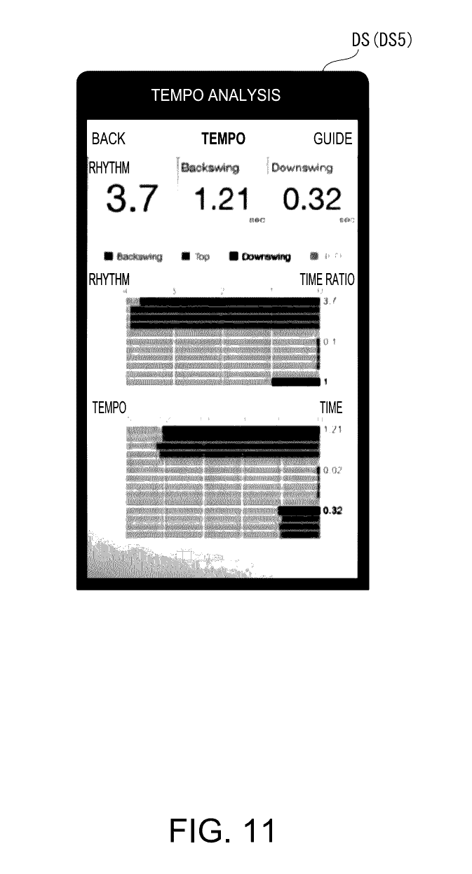

FIGS. 7 to 11 show examples of an analysis result screen DS (DS1 to DS5) showing the result of analysis by the analyzer 359. Specifically, FIGS. 7 to 11 show an example of a swing analysis result screen DS1, an impact analysis result screen DS2, a speed analysis result screen DS3, a shaft rotation analysis result screen DS4, and a tempo analysis result screen DS5.

For example, the analyzer 359 carries out swing analysis of the trajectory or the like of the club, impact analysis of the face angle or the like at impact, speed analysis of the head speed or the like, shaft rotation analysis of the rotation angle of the shaft or the like, and tempo analysis of the rhythm or the like of the swing, on the basis of the results of measurement by the movement sensors 21 attached to the body and the club. The results of these analyses by the analyzer 359 are included in the analysis result screen DS (DS1 to DS5) generated by the screen generator 354, that is, the analysis result screen DS whose examples are shown in FIGS. 7 to 11, and thus displayed on the display 321.

### Configuration of Difference Extractor

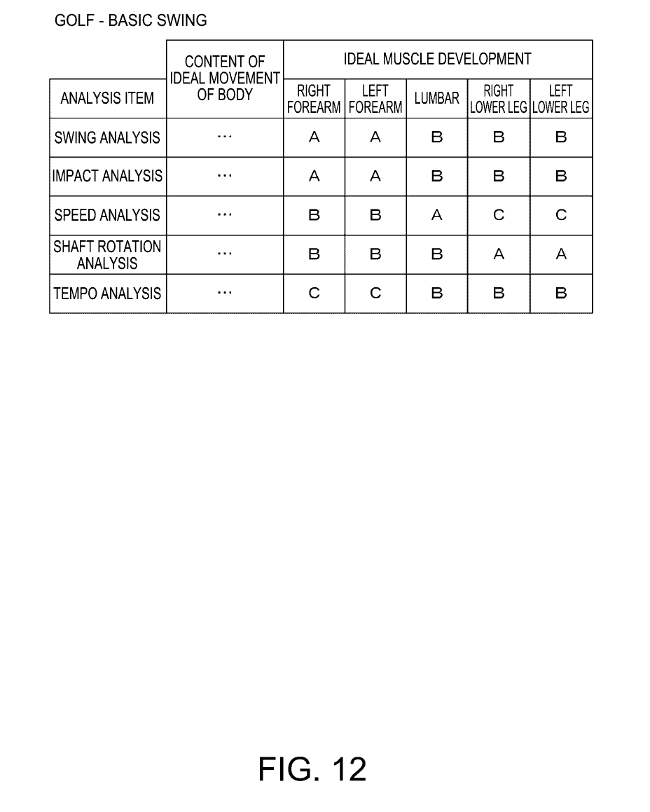

FIG. 12 shows an example of an ideal form of basic swing in golf (a content of an ideal movement and ideal muscle development), of the ideal forms for each type stored in the memory 34.

Back to FIG. 3, the difference extractor 360 extracts the difference between the movement of the user US and the ideal form on the basis of the result of the analyses by the analyzer 359 and the ideal form for each scheduled exercise type stored in the memory 34, and regards this difference as the current problem of (challenge for) the user US.

Here, the ideal form for each scheduled exercise type is stored in the memory 34, as described above. The ideal form includes a content of an ideal movement of the body and ideal muscle development. For example, with respect to the basic swing in golf included in the scheduled exercise types, a content of an ideal movement of the body and ideal muscle development corresponding to each of the analysis items are stored as an ideal form in the memory 34, as shown in FIG. 12.

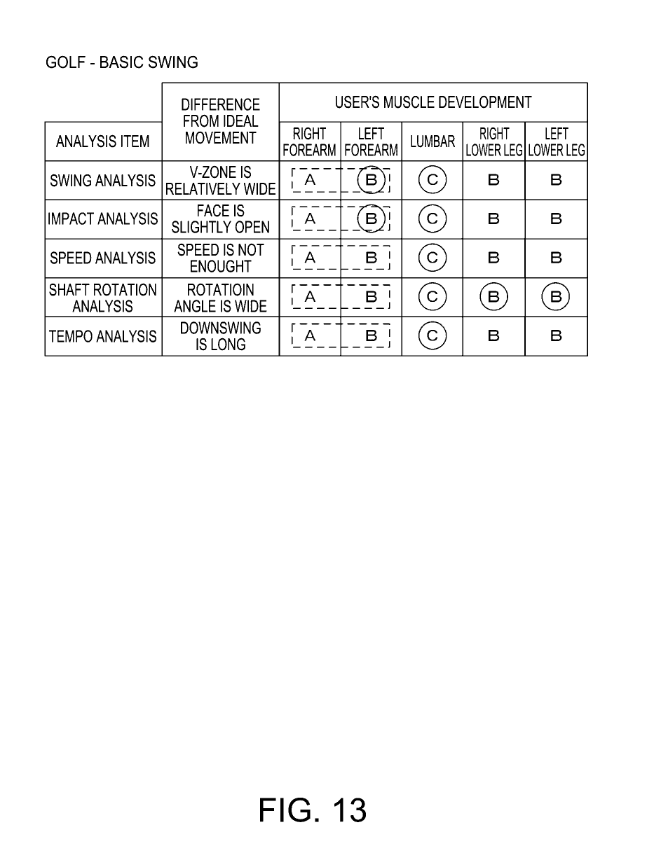

FIG. 13 shows an example of the difference between the content of an ideal movement and the content of the movement of the user US, and the difference between the ideal muscle development and the muscle development of the user US.

The difference extractor 360 extracts the difference of the content of the movement of the user US analyzed by the analyzer 359 from the content of the ideal movement, with respect to each of the analysis items. For example, the difference extractor 360 extracts that “the V-zone is relatively wide” on the basis of the swing analysis, that “the face is slightly open” on the basis of the impact analysis, that “the speed is not enough” on the basis of the speed analysis, that “the rotation angle is wide” on the basis of the shaft rotation analysis, and that “(the duration of) the downswing is long” on the basis of the tempo analysis, as the difference, that is, as the problem in the movement of the user US, as shown in FIG. 13.

The difference extractor 360 also extracts the difference of the muscle development of the user US evaluated by the evaluator 358, from the ideal muscle development, with respect to each of the items.

Here, the muscle masses in the right forearm, left forearm, lumbar, right lower leg and left lower leg of the user US are evaluated as “A”, “B”, “C”, “B” and “B”, respectively, by the evaluator 358, as shown in FIG. 6. Meanwhile, ideal muscle development is stored in the memory 34, corresponding to each of the analysis items for the “basic swing in golf” as a scheduled exercise type, as shown in FIG. 13.

The difference extractor 360 compares the ideal muscle development with the muscle development at each measurement site on the user. The difference extractor 360 then extracts a measurement site where there is a difference between the ideal muscle development and the user's muscle development, more specifically, a measurement site where the muscle development of the user is poorer than the ideal muscle development, with respect to each analysis item. In the example shown in FIG. 13, the part given a “0” mark is a measurement site where the muscle development of the user US is poorer than the ideal muscle development.

The difference extractor 360 also extracts left and right measurement sites where muscle development is different them, on the basis of the result of the evaluation by the evaluator 358. For example, in the evaluation of the muscle development of the user US, the left and right lower legs are both evaluated as “B” and therefore it is determined that there is a good balance between the left and right lower leg muscles. However, in the case of the left and right forearms, the right forearm is evaluated as “A”, whereas the left forearm is evaluated as “B”. Therefore, the difference extractor 360 extracts the forearms as measurement sites where the balance between the left and right muscles is not good. In the example shown in FIG. 13, the parts indicated by a dashed-line rectangle are measurement sites where the balance between the left and right muscles is not good.

### Configuration of Instruction Content Generator

Back to FIG. 3, the instruction content generator 361 generates an instruction content showing the content of an exercise that should be carried out by the user US, on the basis of the results of the extraction by the difference extractor 360. That is, on the basis of the results of the extraction, the instruction content generator 361 specifies a problem site in the movement made by the user US, that is, a site that should be trained in order to resolve the difference from the ideal form or a site to which the user US should pay attention when moving the body in order to improve the movement.

For example, if the scheduled exercise type is the basic swing in golf and the result of the analysis of the movement made by the user US is as shown in FIG. 13, with respect to the analysis item of swing analysis, the instruction content generator 361 determines the “lack of balance between the left and right due to insufficient muscles in the left forearm” and the “instability in the lower half of the body due to insufficient lumbar muscles”, as the causes of the difference that “the V-zone is relatively wide” found by the swing analysis, and specifies the left forearm and lumbar as problem sites.

The instruction content generator 361 then generates an instruction content indicating “muscles located in the left forearm (for example, palmaris longus muscle)” and “muscles located in the lumbar area (for example, abdominal muscles and back muscles)” as sites to be trained, in response to the result of the swing analysis. The instruction content generator 361 also generates an example of an exercise menu for these sites.

Meanwhile, even if training is carried out, changes in muscles are generally not observed during the first two weeks or so. Therefore, an instruction content for resolving the difference (problem) of the current movement of the user US is generated. For example, in response to the result of the swing analysis, the instruction content generator 361 generates an instruction content including advice that the user should “try to relax the right forearm on purpose so as to take a balance between the left and right, and also pay attention to the lumbar when swinging a club”.

Such generation of an instruction content is carried out for each of the analysis items determined as having a difference.

Also, an extraction result screen including the content shown in FIG. 13 may be generated and displayed.

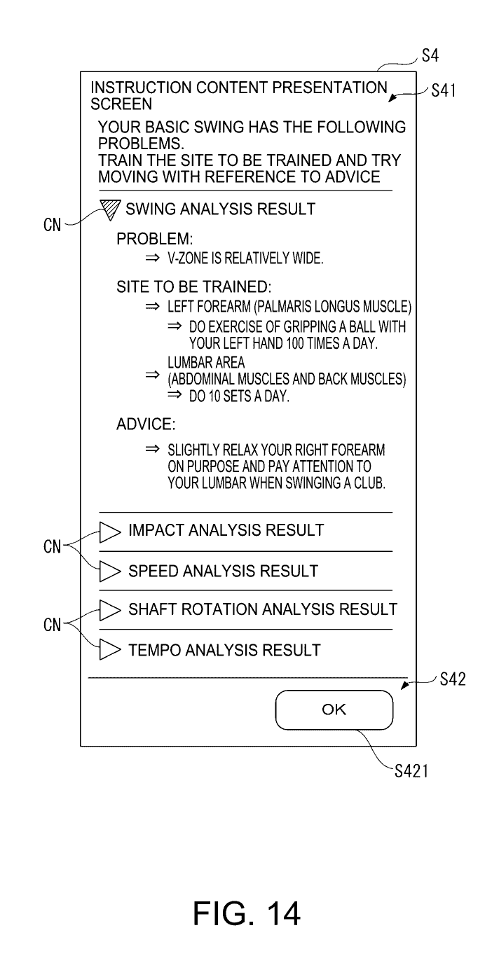

FIG. 14 shows an example of an instruction content presentation screen S4.

As an instruction content is generated by the instruction content generator 361, the screen generator 354 generates an instruction content presentation screen S4 as shown in FIG. 14, including this instruction content, and causes this screen S4 to be displayed on the display 321.

The instruction content presentation screen S4 has a detail display area S41 and a button area S42.

The detail display area S41 includes instruction content setting areas S411 to S415 where an instruction content generated for each of the analysis items is set. In the setting areas S411 to S415, an icon CN in a triangular shape is set. If this icon CN is pressed, the instruction content for the corresponding analysis item can be viewed. If the icon is pressed again, the instruction content disappears. As the instruction content for each analysis item, the instruction content (the problem, the site to be trained, the content of the exercise that should be carried out, and the above advice) generated by the instruction content generator 361 is set.

In the button area S42, an OK button S421 is arranged. If the OK button S421 is pressed, the instruction content presentation screen S4 disappears.

### Exercise Instruction Processing

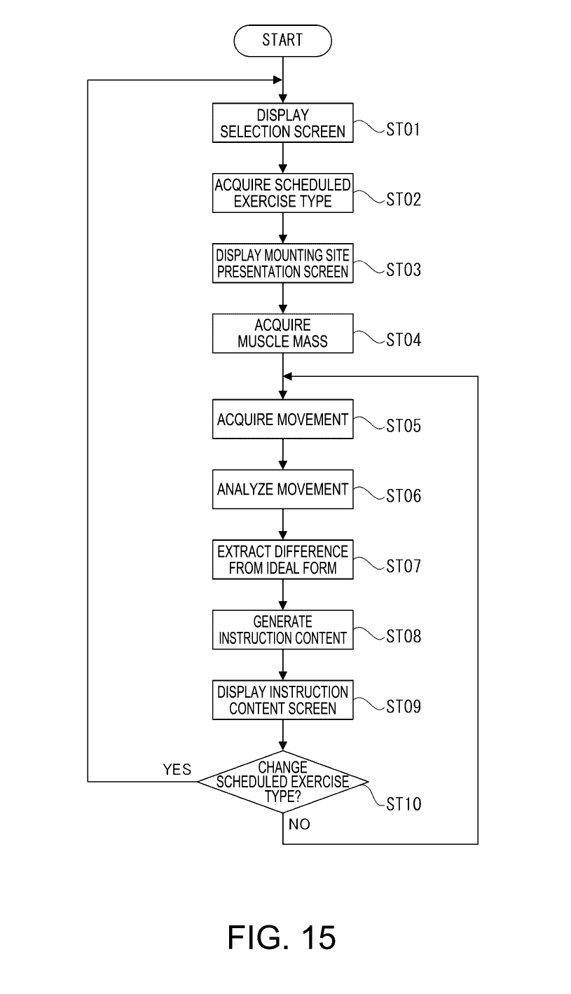

FIG. 15 is a flowchart showing exercise instruction processing.

The controller 35 (AP executor 35B) executes the exercise instruction application stored in the memory 34 and thus executes the following exercise instruction processing. The exercise instruction processing in this embodiment is processing including the instruction content generation method according to the invention.

In the exercise instruction processing, first, the screen generator 354 generates the exercise selection screen S1 and causes the screen S1 to be displayed (step ST01), as shown in FIG. 15.

The information acquirer 355 acquires the scheduled exercise type that is set by an input operation by the user US on the exercise selection screen S1 (step ST02).

Subsequently, the measurement site specifier 356 acquires the measurement site corresponding to the acquired scheduled exercise type from the memory 34, and the screen generator 354 generates the measurement site presentation screen S2 based on the measurement site and causes the screen S2 to be displayed (step ST03).

If the OK button S221 is entered on the measurement site presentation screen S2, a control signal is transmitted to the measuring device 2 via the communicator 33, and a current is supplied from the controller 23 to the measurement sheet 22, as described above. Then, the controller 23 executes the calculation of the biological impedance value based on the voltage value of a current inputted to the controller 23 via the measurement sheet 22, and the information acquirer 355 acquires measurement result information including the biological impedance value for each measurement sheet 22.

On the basis of the measurement result information, the muscle mass acquirer 357 calculates the muscle mass at each measurement site on the body corresponding to the scheduled exercise type that is set (step ST04). On the basis of the calculated muscle mass, the evaluator 358 evaluates the muscle development at each measurement site.

As the user US carries out the exercise of the scheduled exercise type, the information acquirer 355 acquires measurement result information including the result of measurement by each movement sensor 21, from the measuring device 2 (step ST05). The analyzer 359 analyzes the movement of the user US based on the result of the measurement (step ST06).

Subsequently, on the basis of the result of the analysis by the analyzer 359, the difference extractor 360 extracts the differences of the content of the movement of the user US and the muscle development of the user US from the ideal form corresponding to the scheduled exercise type stored in the memory 34 (step ST07).

Next, the instruction content generator 361 generates the instruction content on the basis of the differences extracted by the difference extractor 360 (step ST08).

Then, the screen generator 354 generates the instruction content presentation screen S4 based on the instruction content (step ST09). Thus, the instruction content presentation screen S4 is displayed on the display 321.

Subsequently, the AP executor 35B determines whether an input operation to change the scheduled exercise type is carried out by the user US or not, on the basis of an operation signal inputted from the input unit 31 (step ST10).

If it is determined by the determination processing in step ST10 that an input operation to change the scheduled exercise type is carried out (step ST10: YES), the AP executor 35B returns the processing to step ST01.

Meanwhile, if it is determined by the determination processing in step ST10 that an input operation to change the scheduled exercise type is not carried out (step ST10: NO), the AP executor 35B returns the processing to step ST05 in preparation for the execution of the exercise of the scheduled exercise type by the user US. If the muscle mass is to be measured again, the AP executor 35B returns the processing to step ST04.

On the other hand, if the user US carries out an operation to end the exercise instruction application, the AP executor 35B transmits a control signal to stop the movement detection by the movement sensor 21, to the controller 23 of the measuring device 2, and ends the exercise instruction application.

### Advantageous Effects of First Embodiment

The exercise instruction system 1 according to the above embodiment has the following advantageous effects.

The instruction content generator 361 generates an instruction content on an exercise that should be carried out by the user US, on the basis of the movement of the user US detected by the measuring device 2 and the muscle mass of the user US measured by the measuring device 2 and the muscle mass acquirer 357. The instruction content is included in the instruction content presentation screen S4 and displayed on the display 321. With this configuration, an instruction content that can improve a problem in the movement due to the muscle mass can be presented to the user US. By following the instruction content, the user US can carry out an effective exercise. Therefore, an instruction on an exercise suitable for the user US can be given.

Also, since the configuration of the exercise instruction system 1 enables the provision of an exercise instruction according to the movement and muscle mass of the user US without using any large-scale devices in a gym or the like, the user US can carry out suitable practice or training on his/her own.

Here, the instruction content presented to the user US corresponds to a specific movement such as a swing in a sport that can be selected in the sports selection section S111. By carrying out the exercise on the basis of such an instruction content and thus improving the specific movement, the user US can improve the performance in the sport. Also, whether the specific movement such as a swing in a sport is good or bad can be determined relatively easily because an ideal form of the specific movement is already established. Therefore, a problem in the movement of the user US can be grasped relatively easily and an instruction suitable for the user can be securely given.

The difference extractor 360 extracts the difference between the content of an ideal movement of the body included in the ideal form and the content of the movement of the user US, and the instruction content generator 361 generates an instruction content corresponding to a muscle site to resolve the difference, on the basis of an evaluation of the muscle development of the user US based on the measured muscle mass. Thus, by giving an instruction on the way of moving the muscle or an instruction on the muscle with insufficient muscle strength, it is possible to bring the movement of the user US closer to the ideal movement. Therefore, the user US can carry out an effective exercise on his/her own.

The instruction content generator 361 generates an instruction content including a muscle site to be trained in order to resolve the difference between the content of the ideal movement of the body and the content of the movement of the user US. Thus, by training the muscle indicated by the presented instruction content (in the example shown in FIG. 14, muscles in the left forearm and the lumbar area), the user US can securely bring his/her movement closer to the ideal movement. Therefore, the user US can carry out an effective exercise on his/her own.

The instruction content generated by the instruction content generator 361 includes the way of using the muscle which resolves the difference. Thus, by putting into practice the way of using the muscle indicated by the presented instruction content, the user US can securely bring his/her movement closer to the ideal movement. Therefore, the user US can carry out an effective exercise on his/her own.

An ideal form for each of the scheduled exercise types is stored in the memory 34, and the difference extractor 360 acquires, from the memory 34, an ideal form corresponding to a scheduled exercise type which is a specific movement in a sport selected by the user, and extracts the difference. Thus, since the ideal form is stored in the memory 34, the content of the ideal movement of the body included in the ideal form and the content of the movement carried out by the user US can be securely compared with each other and the difference can be securely extracted. Thus, an instruction content on the exercise of the scheduled exercise type carried out by the user US, that is, an instruction content to improve the specific movement, can be securely presented.

The information processing device 3 has the input unit 31, which accepts an input operation by the user US, and the information acquirer 355, which acquires a scheduled exercise type for the user US on the basis of the input operation. The difference extractor 360 acquires an ideal form corresponding to the acquired scheduled exercise type from the memory 34, and extracts the difference between the content of an ideal movement of the body included in the ideal form and the content of the movement of the user US and the difference between ideal muscle development and the muscle development of the user US. Thus, the ideal form corresponding to the scheduled exercise type can be acquired from the memory 34 securely and swiftly, and comparison between an ideal form of a different type and the movement of the user US can be restrained. Therefore, an appropriate instruction on the exercise carried out by the user US can be securely given.

The measuring device 2 has the measurement sheet 22 as a measurer to be mounted on the user US. A measurement site which is a measurement site of a muscle corresponding to a scheduled exercise type selected by the user US and where the measurement sheet 22 is mounted is shown on the measurement site presentation screen S2. Thus, the measurement sheet 22 can be restrained from being mounted at a site unsuitable for the scheduled exercise type, on the user US, and the measurement sheet 22 can be securely mounted at an appropriate site on the body of the user US. Therefore, the muscle mass at the site that is appropriate for the exercise of the scheduled exercise type can be securely measured.

### Second Embodiment

Next, a second embodiment of the invention will be described.

An exercise instruction system according to this embodiment has a configuration similar to that of the above exercise instruction system and also has a server which generates the instruction content, and the information processing device acquires and displays the instruction content generated by the server. These are features of the exercise instruction system according to this embodiment that are different from the exercise instruction system 1. In the description below, parts that are the same or substantially the same as those described above are denoted by the same reference numbers and are not described further in detail.

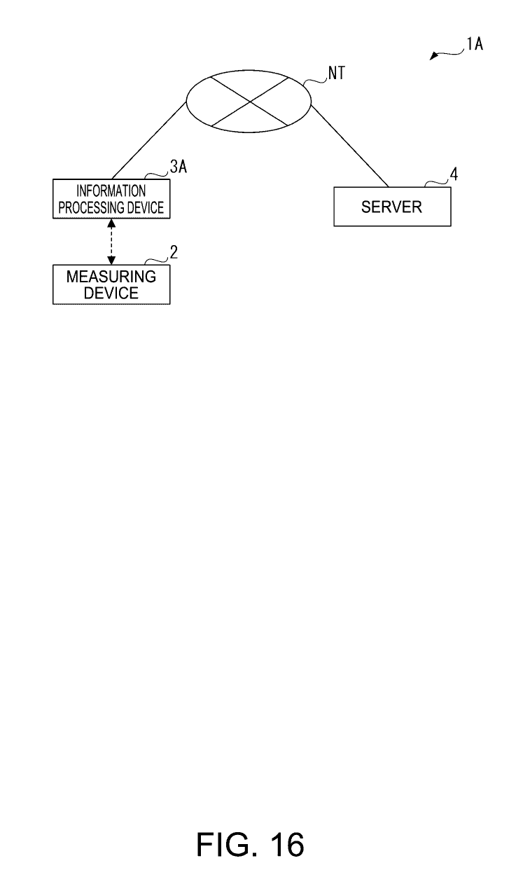

FIG. 16 is a block diagram showing the configuration of an exercise instruction system 1A according to this embodiment.

The exercise instruction system 1A according to this embodiment includes a measuring device 2 and an information processing device 3A that are directly used by a user US, and also includes a server 4 connected for communication with the information processing device 3A via a network NT, as shown in FIG. 16.

The exercise instruction system 1A is the same as the exercise instruction system 1 in that the information processing device 3A acquires the measurement result information from the measuring device 2. However, the server 4 carries out processing such as analysis of the measurement result information and preparation of the instruction content, and the information processing device 3A presents the information acquired from the server 4, by causing the display 321 to display the information or the like. This is a feature of the exercise instruction system 1A that is different from the exercise instruction system 1.

Hereinafter, the configurations of the information processing device 3A and the server 4 in the exercise instruction system 1A will be described. The measuring device 2 in the exercise instruction system 1A has a configuration similar to the above.

### Configuration of Information Processing Device

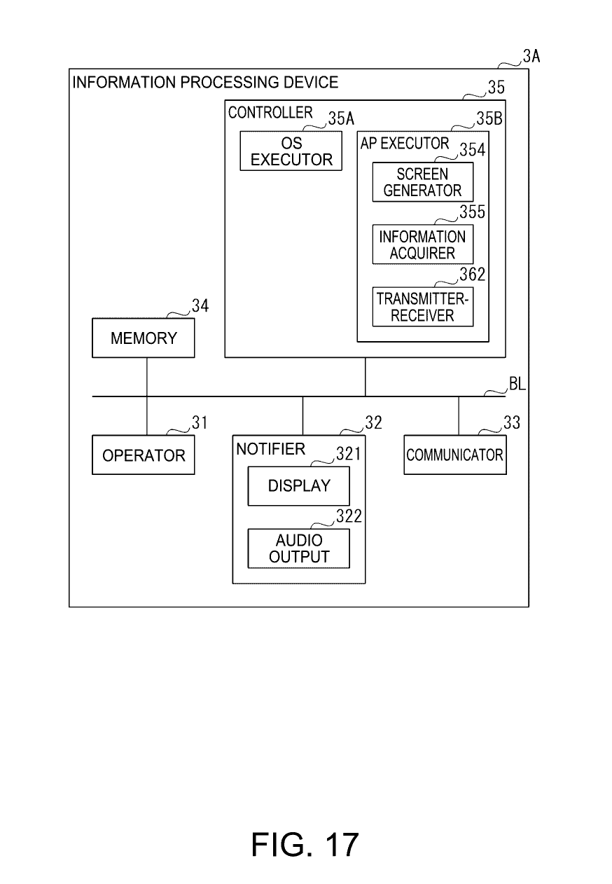

FIG. 17 is a block diagram showing the configuration of the information processing device 3A.

As shown in FIG. 17, the information processing device 3A has a configuration and functions similar to those of the information processing device 3, but the configuration of the AP executor 35B is different because the exercise instruction application stored in the memory 34 is different from the exercise instruction application described in the first embodiment. Specifically, the AP executor 35B of the information processing device 3A has a screen generator 354, an information acquirer 355 and a transmitter-receiver 362 which function by having the exercise instruction application executed.

Of these components, the transmitter-receiver 362 transmits information acquired by the information acquirer 355 to the server 4 via the communicator 33 and also acquires information transmitted from the server 4 via the communicator 33.

For example, the transmitter-receiver 362 transmits information inputted and selected by the user US such as the scheduled exercise type and personal information, and the measurement result information acquired from the measuring device 2, to the server 4.

The transmitter-receiver 362 also acquires various kinds of information transmitted from the server 4, that is, information to generate the respective screens S1 to S4 and DS. This enables the screen generator 354 to generate the screens S1 to S4 and DS and therefore enables the display 321 to display the screens S1 to S4 and DS.

### Configuration of Server

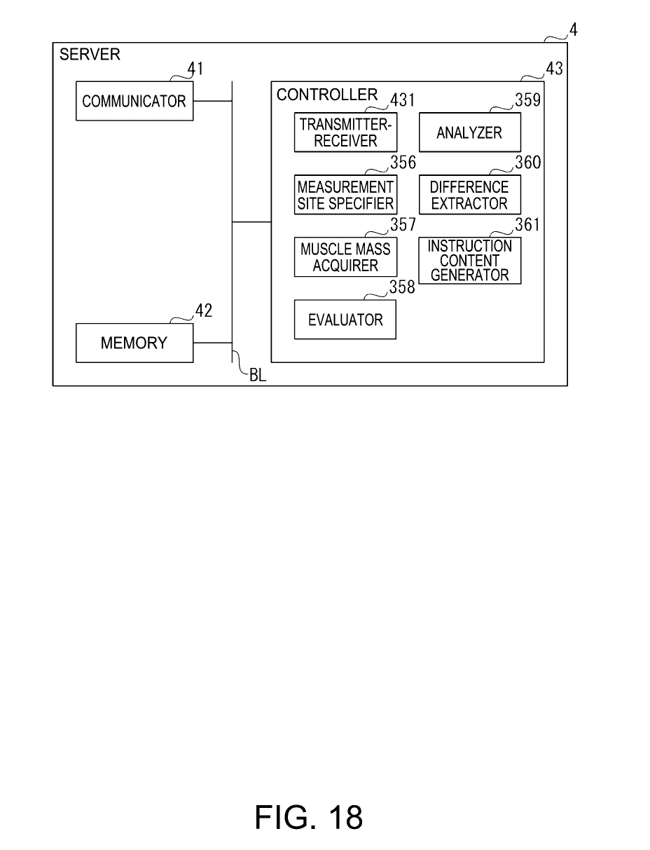

FIG. 18 is a block diagram showing the configuration of the server 4.

The server 4 is equivalent to the instruction content generation device according to the invention, and acquires the measurement result information received from the information processing device 3A and information corresponding to an input operation by the user and executes a part of the processing executed by the foregoing information processing device 3. The server 4 has at least a communicator 41, a memory 42 and a controller 43, as shown in FIG. 18.

Of these components, the communicator 41 is connected for communication with the information processing device 3A via the network NT such as the internet, under the control of the controller 43.

The memory 42 stores an OS and data that are necessary for the server 4 to operate. Moreover, the memory 42 stores an exercise instruction program to execute exercise instruction processing, described later, and also stores various kinds of information stored in the memory 34.

For example, the memory 42 stores unique information (IP address or the like) of the information processing device 3A capable of communicating with the server 4 and personal information of the user US. Also, the memory 42 stores the scheduled exercise type transmitted and acquired from the information processing device 3A and the measurement result information from the measuring device 2 in association with the time and date information and the unique information of the information processing device 3A (or the unique information of the user US). Moreover, the memory 42 stores the measurement site to measure the muscle mass and the ideal form corresponding to each scheduled exercise type.

The controller 43 has a processing circuit such as a CPU, and executes the program stored in the memory 42 and autonomously controls operations of the server 4. The controller 43 also processes information received from the information processing device 3A and transmits the result of the processing to the information processing device 3A. The controller 43 has a transmitter-receiver 431, a measurement site specifier 356, a muscle mass acquirer 357, an evaluator 358, an analyzer 359, a difference extractor 360 and an instruction content generator 361, each of which functions by having the exercise instruction program that is stored in memory 42 executed.

Of these components, the transmitter-receiver 431 is equivalent to the body motion acquirer and the type acquirer according to the invention, and acquires various kinds of information received from the information processing device 3A via the communicator 41. The transmitter-receiver 431 also transmits the results of processing by the respective functional components 356 to 361 to the corresponding information processing device 3A.

By this transmitter-receiver 431, the measurement site specified by the measurement site specifier 356 according to the acquired scheduled exercise type is transmitted to the corresponding information processing device 3A. This enables the screen generator 354 of the information processing device 3A to generate the measurement site presentation screen S2.

Also, by the transmitter-receiver 431, the evaluation by the evaluator 358 with respect to the muscle mass of the user US (evaluation of muscle development) is transmitted to the information processing device 3A. This enables the screen generator 354 to generate the muscle mass presentation screen S3.

Moreover, by the transmitter-receiver 431, the result of analysis by the analyzer 359 with respect to the movement of the user US when carrying out the exercise of the scheduled exercise type is transmitted to the information processing device 3A. This enables the screen generator 354 to generate the analysis result screen DS (DS1 to DS5).

Also, by the transmitter-receiver 431, the instruction content generated by the instruction content generator 361 on the basis of the difference from the ideal form extracted by the difference extractor 360 is transmitted to the information processing device 3A. This enables the screen generator 354 to generate the instruction content presentation screen S4.

### Exercise Instruction Processing

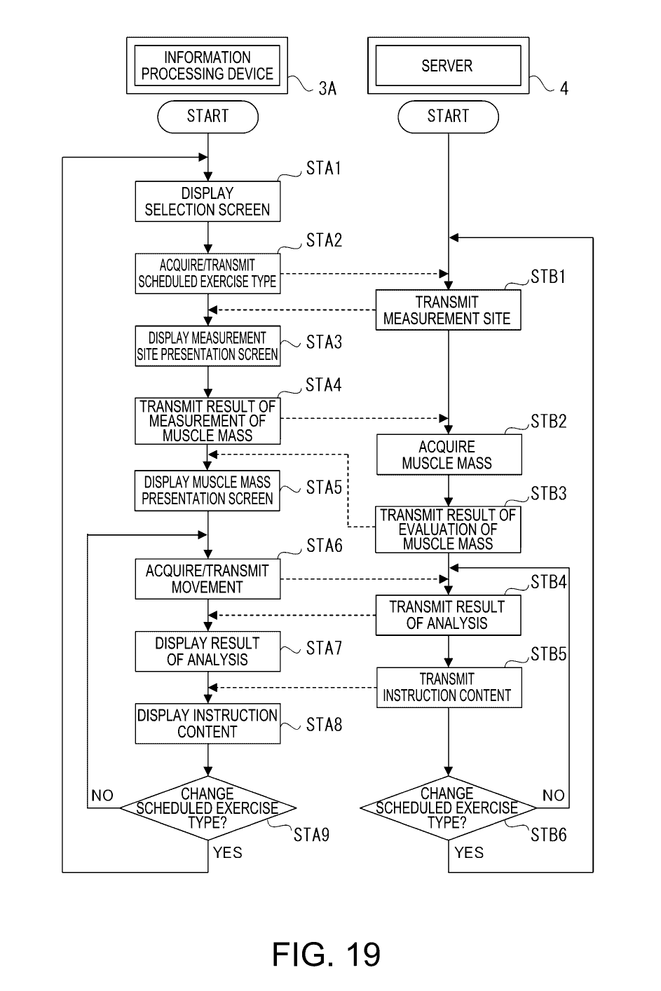

FIG. 19 is a flowchart showing the exercise instruction processing by the exercise instruction system 1A.

In the exercise instruction system 1A, the information processing device 3A and the server 4 collaborate to execute the exercise instruction processing described below. The exercise instruction processing in this embodiment is processing including the instruction content generation method according to the invention.

In this exercise instruction processing, first, the screen generator 354 of the information processing device 3A generates the exercise selection screen S1 and causes the screen S1 to be displayed (step STA1), as shown in FIG. 19.

Next, the information acquirer 355 acquires a scheduled exercise type for the user US on the basis of an input operation by the user US on the input unit 31 when the screen S1 is displayed, and the transmitter-receiver 362 transmits information indicating the scheduled exercise type to the server 4 (step STA2). Subsequently, the AP executor 35B of the information processing device 3A shifts the processing to step STA3.

In the server 4, when the information indicating the scheduled exercise type is received from the information processing device 3A, the measurement site specifier 356 acquires a measurement site to measure the muscle mass corresponding to the scheduled exercise type from the memory 42 and transmits information indicating the measurement site to the information processing device 3A (step STB1). Subsequently, the controller 43 of the server 4 shifts the processing to step STB2.

In the information processing device 3A, where the information indicating the measurement site is received from the server 4, the screen generator 354 generates the measurement site presentation screen S2 on the basis of the information and causes the screen S2 to be displayed (step STA3).

Then, when the OK button S221 is pressed on the screen S2, a control signal is transmitted to the measuring device 2 and muscle mass measuring processing (to be more precise, biological impedance value measuring processing) is carried out. The result of the measurement acquired by the information acquirer 355 is transmitted to the server 4 by the transmitter-receiver 362 (step STA4). Subsequently, the AP executor 35B shifts the processing to step STA5.

In the server 4, where the result of the measurement is received through step STA4, the muscle mass acquirer 357 calculates the muscle mass at each measurement site on the basis of the result of the measurement, and the evaluator 358 evaluates the muscle development of the user US on the basis of this muscle mass (step STB2).

Then, the transmitter-receiver 431 transmits information indicating the calculated muscle mass and the result of the evaluation on the muscle development to the information processing device 3A (step STB3). Subsequently, the controller 43 shifts the processing to step STB4.

In the information processing device 3A, where the information transmitted in step STB3 is acquired, the screen generator 354 generates the muscle mass presentation screen S3 on the basis of this information and causes the screen S3 to be displayed (step STA5). The display of the screen S3 is optionally decided by the user US, as described above.

Then, as the user US carries out the exercise of the scheduled exercise type and the information acquirer 355 of the information processing device 3A acquires the result of measurement by the movement sensor 21 when the user US carries out the exercise, the transmitter-receiver 362 transmits the result of the measurement to the server 4 (step STA6). Subsequently, the AP executor 35B shifts the processing to step STAT.

In the server 4, where the result of the measurement transmitted in step STA6 is received, the analyzer 359 analyzes the result of the measurement and the transmitter-receiver 431 transmits the result of the analysis by the analyzer 359 to the information processing device 3A (step STB4).

In the information processing device 3A, where the result of the analysis transmitted in step STB4 is acquired, the screen generator 354 generates the analysis result screen DS (DS1 to DS5) on the basis of the result of the analysis and causes the screen DS to be displayed (step STAT). The display of the screen DS is also optionally decided by the user US.

Meanwhile, in the server 4, following step STB4, the difference extractor 360 extracts the difference between the ideal movement of the body corresponding to each scheduled exercise type stored in the memory 42 and the movement of the user US, and the difference between the ideal muscle development corresponding to each scheduled exercise type stored in the memory 42 and the muscle development of the user US, and the instruction content generator 361 generates the instruction content on the basis of the extracted differences. Then the transmitter-receiver 431 transmits the generated instruction content to the information processing device 3A (step STB5).

In the information processing device 3A, where the instruction content transmitted in step STB5 is received, the screen generator 354 generates the instruction content presentation screen S4 on the basis of this instruction content and causes the screen S4 to be displayed (step STA8).

Subsequently, the AP executor 35B determines whether an input operation to change the scheduled exercise type is carried out by the user US or not (step STA9), as in the foregoing step ST10.

If it is determined by this determination processing in step STA9 that an input operation to change the scheduled exercise type is carried out (step STA9: YES), the AP executor 35B returns the processing to step STA1.

Meanwhile, if it is determined by the determination processing of step STA9 that an input operation to change the scheduled exercise type is not carried out (step STA9: NO), the AP executor 35B returns the processing to step STA6 in preparation for the execution of the exercise of the scheduled exercise type by the user US. If the muscle mass is to be measured again, the AP executor 35B returns the processing to step STA4.

On the other hand, if the user US carries out an operation to end the exercise instruction application, the AP executor 35B transmits a control signal to stop the movement detection by the movement sensor 21, to the measuring device 2, and ends the exercise instruction application.

After step STB5, the controller 43 determines whether an input operation to change the scheduled exercise type is carried out by the user US or not, on the basis of the information received from the information processing device 3A (step STB6).

If it is determined by this determination processing of step STB6 that an input operation to change the scheduled exercise type is carried out (step STB6: YES), the controller 43 returns the processing to step STB1.

Meanwhile, if it is determined by the determination processing of step STB6 that an input operation to change the scheduled exercise type is not carried out (step STB6: NO), the controller 43 returns the processing to step STB4 in preparation for the execution of the exercise of the scheduled exercise type by the user US. If the muscle mass is to be measured again, the controller 43 returns the processing to step STB2.

On the other hand, if a control signal indicating that the user US has carried out an operation to end the currently executed exercise instruction application at the information processing device 3A is received, or if communication with the information processing device 3A is not carried out for a predetermined period of time, the controller 43 ends the currently executed exercise instruction application.

This ends the exercise instruction processing.

In this embodiment, the server 4 is configured in such a way that the transmitter-receiver 431 transmits necessary information to generate the respective screens S1 to S4 and DS, to the information processing device 3A. However, this example is not limiting. The controller 43 may have the screen generator 354 for generating the screens S1 to S4 and DS, and the transmitter-receiver 431 may transmit image information of the generated screens S1 to S4 and DS to the information processing device 3A.

### Advantageous Effects of Second Embodiment

The exercise instruction system 1A according to this embodiment has the following advantageous effects in addition to advantageous effects similar to those of the exercise instruction system 1.

In the exercise instruction system 1A, the processing of calculating the muscle mass and the processing of generating the instruction content are carried out by the server 4 connected for communication with the information processing device 3A. This enables a reduction in the processing load on the information processing device 3A and also enables the server 4 to centrally manage information about a plurality of users.

### Modifications of Embodiments

The invention is not limited to the embodiments and includes modifications, improvements and the like within a scope that can achieve the objectives of the invention.

In the embodiments, an instruction content about a specific movement in a sport is generated and presented. However, the invention is not limited to this. For example, the muscle development of a top player of a certain sport may be referred to. The difference between the muscle development of the top player and the muscle development of the user may be extracted and an instruction content to resolve this difference may be generated. In this case, an instruction content indicating what part of the body should be trained may be generated and presented.

The specific movement need not be a movement that ends in a relatively short time such as a swing of a club, and may also be a movement that continues for a relatively long time such as a running form in distance running.

In the embodiments, the ideal form including the content of the ideal movement of the body and the ideal muscle development is stored in the memory 34, 42, corresponding to each exercise type. However, the invention is not limited to this. That is, the ideal form need not be stored as long as a problem due to the muscle development of the user US can be grasped on the basis of the result of analysis by the analyzer 359. It is also possible to store only one of the contents included in the ideal form.

In the embodiments, the measurement site presentation screen S2 presents a measurement site on a muscle corresponding to the scheduled exercise type selected by the user US is presented to the user US. However, the invention is not limited to this. That is, the display of such a screen S2 may be omitted.

Also, the measurement site presentation screen S2 need not necessarily be displayed after a scheduled exercise type is selected or inputted. For example, even if training of a muscle is carried out, changes in the muscle are not observed during the first two weeks or so, as described above. Therefore, the screen S2 may be configured to be displayed every predetermined period such as two weeks. Moreover, a measurement site presentation screen S2 which shows a measurement site having a problem with the muscle development such as sites where the balance between the left and right is lacking and which does not show a measurement site having no particular problem, may be displayed. In this way, if the number of measurement sites to measure the muscle mass is reduced, the burden on the user US can be reduced.

In the embodiments, the generated instruction content includes the muscle site that should be trained by the user US in order to resolve the difference extracted by the difference extractor 360 and the way of using the muscle in order to resolve the difference. However, the invention is not limited to this. For example, the instruction content may include only one of the muscle site that should be trained by the user US and the way of using the muscle in order to resolve the difference. Also, the instruction content may include different information from this.

In the embodiments, the measuring device 2 transmits the result of measurement by the movement sensor 21 and the biological impedance value calculated with the use of the measurement sheet 22 to the information processing device 3, 3A as detection result information. However, the invention is not limited to this. For example, the measuring device 2 mounted on the user US may include the functions of the information processing device 3. That is, the exercise instruction system of the invention may be formed by a single device. Also, the measuring device 2 and the information processing device 3A may be integrated as a single unit.

The contents included in the screens S1 to S4 and DS (DS1 to DS5) described in the embodiments and the layouts of the screens S1 to S4 and DS are not limited to the contents and layouts shown in the drawings. That is, the configuration of each screen can be changed according to need.

In the embodiments, the movement sensor 21 is mounted on the user US. In this case, the movement sensor 21 may be mounted on the user US via a configuration worn by the user US. For example, if the user US wears a wearable component such as eyeglasses, an HMD (head-mounted display) and a wristwatch, the movement sensor 21 may be attached to the wearable components. That is, the movement sensor 21 need not be directly mounted on the body of the user US as long as the movement sensor 21 can measure movements of the user US.

In the embodiments, the exercise instruction program according to the invention is included in the exercise instruction application, and the exercise instruction application is stored in the memory 34, 42 in advance. However, the invention is not limited to this. For example, the exercise instruction program may be read out from a recording medium such as a disc recording medium and then executed, with the execution of the exercise instruction application. Also, the exercise instruction program may be acquired from a server or the like on a network and then executed.

What is claimed is:

1. An exercise instruction device comprising:
a body motion acquirer which acquires a result of detection of a body motion of a user; and
a muscle mass acquirer which acquires a result of measurement of a muscle mass of the user;
wherein an instruction content on an exercise that should be carried out by the user is generated on the basis of the result of the detection of the body motion and the result of the measurement of the muscle mass.

2. The exercise instruction device according to claim 1, wherein
the instruction content is an instruction content that improves a specific movement in a sport.

3. The exercise instruction device according to claim 2, further comprising:
a difference extractor which extracts a difference of the specific movement from an ideal form, on the basis of the result of the detection of the body motion when the user carries out the specific movement; and
an instruction content generator which generates the instruction content corresponding to a muscle site which resolves the difference that is extracted, on the basis of the result of the measurement of the muscle mass.

4. The exercise instruction device according to claim 3, wherein
the instruction content generator generates the instruction content including a muscle site that should be trained in order to resolve the difference.

5. The exercise instruction device according to claim 3, wherein
the instruction content generator generates the instruction content including a way of using the muscle which resolves the difference.

6. The exercise instruction device according to claim 3, wherein
the instruction content generator has a memory which stores the ideal form, and
the difference extractor acquires the ideal form corresponding to the specific movement from the memory and extracts the difference.

7. The exercise instruction device according to claim 6, further comprising:
an input unit which accepts an input operation by the user; and
a type acquirer which acquires a scheduled exercise type that is a type of exercise scheduled to be carried out by the user, on the basis of the input operation;
wherein the difference extractor acquires the ideal form from the memory on the basis of the scheduled exercise type that is acquired.

8. The exercise instruction device according to claim 1, further comprising:
an input unit which accepts an input operation by the user;
a type acquirer which acquires a scheduled exercise type that is a type of exercise scheduled to be carried out by the user, on the basis of the input operation; and
a measurement site presenter which presents a measurement site where the muscle mass is measured, on the basis of the scheduled exercise type that is acquired.

9. An instruction content generation method carried out using an instruction content generation device which generates an instruction content on an exercise carried out by a user, the method comprising:
measuring a body motion and a muscle mass of the user; and
generating an instruction content on an exercise that should be carried out by the user, on the basis of a result of the measurement of the body motion and the muscle mass.

10. An instruction content generation device comprising:
a body motion acquirer which acquires a result of detection of a body motion of a user;
a muscle mass acquirer which acquires a result of measurement of a muscle mass of the user; and
an instruction content generator which generates an instruction content on an exercise that should be carried out by the user, on the basis of the result of the detection of the body motion and the result of the measurement of the muscle mass.

11. An exercise instruction system comprising:
a body motion detection device which detects a body motion of a user;
a muscle mass measuring device which measures a muscle mass of the user; and
an exercise instruction device which presents an instruction content on an exercise that should be carried out by the user, on the basis of a result of detection by the body motion detection device and a result of measurement by the muscle mass measuring device.

12. The exercise instruction system according to claim 11, wherein
the instruction content is an instruction content that improves a specific movement in a sport.

13. The exercise instruction system according to claim 12, further comprising
an instruction content generation device which generates the instruction content,
wherein the instruction content generation device includes:
a difference extractor which extracts a difference of the specific movement from an ideal form on the basis of the result of the detection by the body motion detection device when the user carries out the specific movement; and
an instruction content generator which generates the instruction content corresponding to a muscle site which resolves the difference that is extracted, on the basis of the muscle mass of the user measured by the muscle mass measuring device, and
the exercise instruction device presents the instruction content generated by the instruction content generation device.

14. The exercise instruction system according to claim 13, wherein
the instruction content generator generates the instruction content including a muscle site that should be trained in order to resolve the difference.

15. The exercise instruction system according to claim 13, wherein
the instruction content generator generates the instruction content including a way of using the muscle that resolves the difference.

16. The exercise instruction system according to claim 13, wherein
the instruction content generation device has a memory which stores the ideal form, and
the difference extractor acquires the ideal form corresponding to the specific movement from the memory and extracts the difference.

17. The exercise instruction system according to claim 16, wherein
the exercise instruction device includes:
an input unit which accepts an input operation by the user; and
a type acquirer which acquires a scheduled exercise type which is a type of exercise scheduled to be carried out by the user, on the basis of the input operation, and
the difference extractor acquires the ideal form from the memory on the basis of the scheduled exercise type that is acquired.

18. The exercise instruction system according to claim 11, wherein
the muscle mass measuring device has a measurer which is mounted on the user for measuring the muscle mass, and
the exercise instruction device includes:
an input unit which accepts an input operation by the user;
a type acquirer which acquires a scheduled exercise type which is a type of exercise scheduled to be carried out by the user, on the basis of the input operation; and
a measurement site presenter which presents a measurement site where the measurer is mounted to measure the muscle mass, on the basis of the scheduled exercise type that is acquired.

19. An exercise instruction device wherein
a result of detection of a body motion of a user is acquired,
a result of measurement of a muscle mass of the user is acquired, and
an instruction content on an exercise that should be carried out by the user is presented on the basis of the result of the detection of the body motion and the result of the measurement of the muscle mass.
